(19) United States
(12) Patent Application Publication
(10) Pub. No.: US 2025/0295047 A1
(43) Pub. Date: Sep. 25, 2025

(54) SYSTEMS AND METHODS FOR AN AGRICULTURAL IMPLEMENT

(71) Applicant: CNH Industrial America LLC, New Holland, PA (US)

(72) Inventors: Heather Humphreys Paxinos, Lemont, IL (US); Michael R. Cozza, Pittsburgh, PA (US); Scott Glovier, McMurray, PA (US)

(21) Appl. No.: 18/614,874

(22) Filed: Mar. 25, 2024

(51) Int. Cl. A01B 63/28; A01B 29/04; A01B 63/00

(52) U.S. Cl. CPC A01B 63/28; A01B 29/046; A01B 63/008

(57) ABSTRACT

An agricultural system can include an implement including a frame assembly. A basket assembly can be operably coupled with the frame assembly. A basket actuator can be operably coupled with the basket assembly and the frame assembly. The basket actuator can be configured to alter a position of the basket assembly relative to the frame assembly. A computing system can be communicatively coupled to the basket actuator. The computing system can include a processor and associated memory, the memory stores instructions that, when implemented by the processor, configure the computing system to receive a defined output characteristic, receive data indicative of a determined clay content of soil within the field, and determine a defined basket actuator position based at least partially on the clay content of the soil within the field and the defined output characteristic.

### FIELD OF THE INVENTION

The present subject matter relates generally to tillage implements that may be operated within an agricultural field.

### BACKGROUND OF THE INVENTION

In some cases, to increase agricultural performance from a field, a farmer may cultivate the soil, typically through a tillage operation. For instance, tillage operations may be performed by pulling a tillage implement behind an agricultural work vehicle, such as a tractor. Tillage implements can include one or more ground-engaging tools configured to engage the soil as the implement is moved across the field. For example, in certain configurations, the implement may include one or more harrow discs, leveling discs, rolling baskets, shanks, tines, and/or the like. Such ground-engaging tool(s) loosen and/or otherwise agitate the soil to prepare the field for subsequent planting operations.

During tillage operations, field materials, such as residue, soil, rocks, mud, and/or the like, may become trapped or otherwise accumulate on and/or within ground-engaging tools or between adjacent ground-engaging tools (termed “plugging” or a “plugged condition”). For instance, material accumulation may occur around the exterior of a basket assembly (e.g., on the blades or bars of the basket assembly) and/or within the interior of the basket assembly. Such accumulation of field materials may prevent the basket assembly from performing in a desired manner during the performance of a tillage operation. In such instances, an operator may take certain corrective actions to remove the material accumulation. However, it may be difficult for the operator to detect or determine the plugged condition of a basket assembly or any other suitable ground-engaging tool(s) when viewing the ground-engaging tools from the operator's cab.

Accordingly, an improved system and method for limiting or avoiding plugging of ground-engaging tools of an agricultural implement would be welcomed in the technology. A system and method for limiting or avoiding plugging of ground-engaging tools of an autonomous agricultural implement would also be useful.

### BRIEF DESCRIPTION OF THE INVENTION

Aspects and advantages of the technology will be set forth in part in the following description, or may be obvious from the description, or may be learned through practice of the technology.

In some aspects, the present subject matter is directed to an agricultural system that includes an implement including a frame assembly. A basket assembly is operably coupled with the frame assembly. A basket actuator is operably coupled with the basket assembly and the frame assembly. The basket actuator is configured to alter a position of the basket assembly relative to the frame assembly. A computing system is communicatively coupled to the basket actuator, the computing system including a processor and associated memory. The memory stores instructions that, when implemented by the processor, configure the computing system to receive a defined output characteristic, receive data indicative of a determined clay content of soil within a field, and determine a defined basket actuator position based at least partially on the clay content of the soil within the field and the defined output characteristic.

In some aspects, the present subject matter is directed to a method for operating an agricultural system. The method includes receiving, from one or more field sensors, data indicative of an electrical conductivity of soil. The method also includes determining, with a computing system, a determined clay content of soil based at least partially on the electrical conductivity of the soil.

In some aspects, the present subject matter is directed to an agricultural system that includes an implement including a frame assembly. A basket assembly is operably coupled with the frame assembly. A basket actuator is operably coupled with the basket assembly and the frame assembly. The basket actuator is configured to alter a position of the basket assembly relative to the frame assembly. The system further includes one or more field sensors. A computing system is communicatively coupled to the basket actuator, the computing system including a processor and associated memory. The memory stores instructions that, when implemented by the processor, configure the computing system to receive data indicative of an electrical conductivity of soil, determine a determined clay content of soil within the field based on the electrical conductivity of the soil, and determine a defined basket actuator position based at least partially on the clay content of the soil within the field.

These and other features, aspects, and advantages of the present technology will become better understood with reference to the following description and appended claims. The accompanying drawings, which are incorporated in and constitute a part of this specification, illustrate embodiments of the technology and, together with the description, serve to explain the principles of the technology.

### BRIEF DESCRIPTION OF THE DRAWINGS

A full and enabling disclosure of the present technology, including the best mode thereof, directed to one of ordinary skill in the art, is set forth in the specification, which makes reference to the appended figures, in which:

FIG. 1 illustrates a front perspective view of an agricultural machine in accordance with aspects of the present subject matter;

FIG. 2 illustrates a front perspective view of an agricultural implement in accordance with aspects of the present subject matter;

FIG. 3 illustrates a rear perspective view of the agricultural implement in accordance with aspects of the present subject matter;

FIG. 4 illustrates a block diagram of components of a system for an agricultural machine in accordance with aspects of the present subject matter;

FIG. 5 illustrates various components a block diagram of some of the components of the system for an agricultural machine in accordance with aspects of the present subject matter; and

FIG. 6 illustrates a flow diagram of a method for operating an agricultural system in accordance with aspects of the present subject matter.

Repeat use of reference characters in the present specification and drawings is intended to represent the same or analogous features or elements of the present technology.

### DETAILED DESCRIPTION OF THE INVENTION

Reference now will be made in detail to embodiments of the disclosure, one or more examples of which are illustrated in the drawings. Each example is provided by way of explanation of the discourse, not limitation of the disclosure. In fact, it will be apparent to those skilled in the art that various modifications and variations can be made in the present disclosure without departing from the scope or spirit of the disclosure. For instance, features illustrated or described as part can be used with another embodiment to yield a still further embodiment. Thus, it is intended that the present disclosure covers such modifications and variations as come within the scope of the appended claims and their equivalents.

In this document, relational terms, such as first and second, top and bottom, and the like, are used solely to distinguish one entity or action from another entity or action, without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

As used herein, the terms “first,” “second,” and “third” may be used interchangeably to distinguish one component from another and are not intended to signify a location or importance of the individual components. The terms “coupled,” “fixed,” “attached to,” and the like refer to both direct coupling, fixing, or attaching, as well as indirect coupling, fixing, or attaching through one or more intermediate components or features, unless otherwise specified herein. The terms “upstream” and “downstream” refer to the relative direction with respect to an agricultural product within a fluid circuit. For example, “upstream” refers to the direction from which an agricultural product flows, and “downstream” refers to the direction to which the agricultural product moves. The term “selectively” refers to a component's ability to operate in various states (e.g., an ON state and an OFF state) based on manual and/or automatic control of the component.

Furthermore, any arrangement of components to achieve the same functionality is effectively “associated” such that the functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected” or “operably coupled” to each other to achieve the desired functionality, and any two components capable of being so associated can also be viewed as being “operably couplable” to each other to achieve the desired functionality. Some examples of operably couplable include, but are not limited to, physically mateable, physically interacting components, wirelessly interactable, wirelessly interacting components, logically interacting, and/or logically interactable components.

The singular forms “a,” “an,” and “the” include plural references unless the context clearly dictates otherwise.

Approximating language, as used herein throughout the specification and claims, is applied to modify any quantitative representation that could permissibly vary without resulting in a change in the basic function to which it is related. Accordingly, a value modified by a term or terms, such as “about,” “approximately,” “generally,” and “substantially,” is not to be limited to the precise value specified. In at least some instances, the approximating language may correspond to the precision of an instrument for measuring the value, or the precision of the methods or apparatus for constructing or manufacturing the components and/or systems. For example, the approximating language may refer to being within a ten percent margin.

Moreover, the technology of the present application will be described in relation to exemplary embodiments. The word “exemplary” is used herein to mean “serving as an example, instance, or illustration.” Any embodiment described herein as “exemplary” is not necessarily to be construed as preferred or advantageous over other embodiments. Additionally, unless specifically identified otherwise, all embodiments described herein should be considered exemplary.

As used herein, the term “and/or,” when used in a list of two or more items, means that any one of the listed items can be employed by itself, or any combination of two or more of the listed items can be employed. For example, if a composition or assembly is described as containing components A, B, and/or C, the composition or assembly can contain A alone; B alone; C alone; A and B in combination; A and C in combination; B and C in combination; or A, B, and C in combination.

In general, the present subject matter is directed to agricultural systems and methods for operating the agricultural systems that may incorporate a tillage implement. In some cases, tillage implements are used to remove soil compaction, either surface or deep, and improve the overall soil tilth for improved crop production and growth.

In some examples, the agricultural system includes an implement including a frame assembly. A basket assembly can be operably coupled with the frame assembly. A basket actuator can be operably coupled with the basket assembly and the frame assembly. The basket actuator can be configured to alter a position of the basket assembly relative to the frame assembly.

A computing system can be communicatively coupled to the basket actuator, the computing system including a processor and associated memory, the memory storing instructions that, when implemented by the processor, configure the computing system to receive a defined output characteristic (such as residue sizing, clod sizing, levelness, etc.), receive data indicative of a determined clay content of soil within the field (and/or any other field condition), and determine a defined basket actuator position based at least partially on the clay content of the soil within the field and the defined output characteristic.

In some instances, the data indicative of a determined clay content of soil within the field can include electrical conductivity data. In such cases, one or more field sensors can be configured to capture data indicative of the clay content of the soil. The one or more field sensors may be positioned forward of one or more ground-engaging tools of the implement.

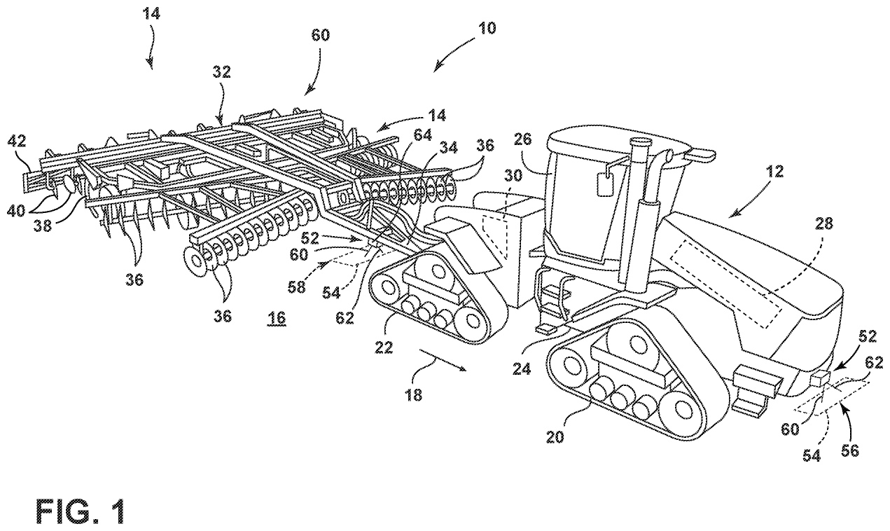

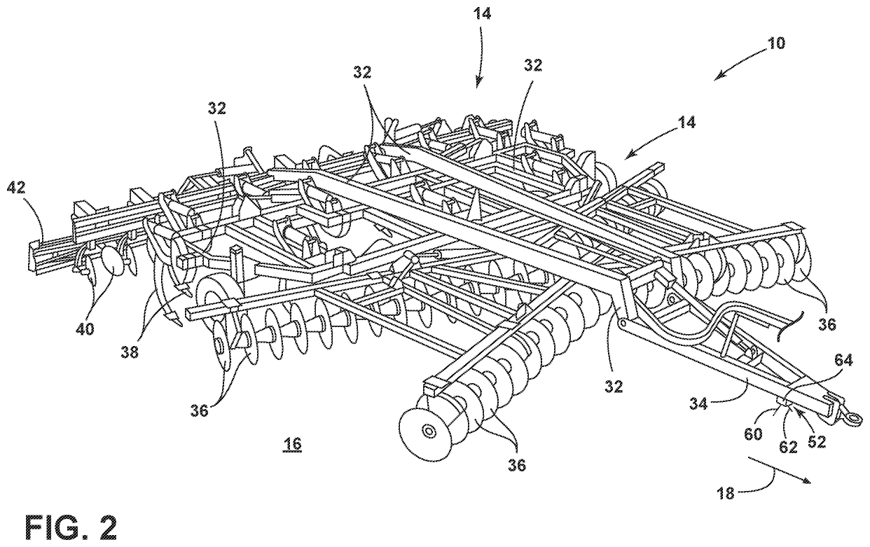

Referring now to drawings, FIGS. 1-3 respectively illustrate a front perspective view, a rear perspective view, and a partial rear perspective view of an agricultural machine 10 in accordance with various aspects of the present subject matter. As shown, the agricultural machine 10 can include a work vehicle 12 and an associated agricultural implement 14. In general, the work vehicle 12 is configured to tow the implement 14 across a field 16 in a direction of travel (e.g., as indicated by arrow 18 in FIG. 1). In the illustrated examples, the work vehicle 12 is configured as an agricultural tractor and the implement 14 is configured as an associated tillage implement. However, in other embodiments, the work vehicle 12 may be configured as any other suitable type of vehicle, such as an agricultural harvester, a self-propelled sprayer, and/or the like. Similarly, the implement 14 may be configured as any other suitable type of implement, such as a planter. Furthermore, the agricultural machine 10 may correspond to any suitable powered and/or unpowered agricultural machine 10 (including suitable vehicles and/or equipment, such as only a work vehicle or only an implement). Additionally, the agricultural machine 10 may include two or more associated vehicles, implements, and/or the like (e.g., a tractor, a planter, and an associated air cart).

As shown in FIGS. 1-3, the work vehicle 12 includes a pair of front track assemblies 20, a pair of rear track assemblies 22, and a frame or chassis 24 coupled to and supported by the track assemblies 20, 22. An operator's cab 26 may be supported by a portion of the chassis 24 and may house various input devices for permitting an operator to control the operation of one or more components of the work vehicle 12 and/or one or more components of the implement 14. Additionally, the work vehicle 12 may include a power plant 28 and a transmission 30 mounted on the chassis 24. The transmission 30 may be operably coupled to the power plant 28 and may provide variably adjusted gear ratios for transferring power to the track assemblies 20, 22 via a drive axle assembly (or via axles if multiple drive axles are employed).

Additionally, as shown in FIGS. 1-3, the implement 14 may generally include a carriage frame assembly 32 configured to be towed by the work vehicle 12 via a pull hitch or tow bar 34 in the direction of travel 18 of the vehicle 12. The carriage frame assembly 32 may be configured to support a plurality of ground-engaging tools, such as a plurality of shanks, disk blades, levelers (e.g., leveling blades), basket assemblies 42, tines, spikes, and/or the like. For example, the carriage frame assembly 32 may be configured to support various gangs of disc blades 36, a plurality of ground-engaging shanks 38, a plurality of levelers 40 (e.g., leveling blades), and a plurality of crumbler wheels or basket assemblies 42. However, in alternative embodiments, the carriage frame assembly 32 may be configured to support any other suitable ground-engaging tools and/or a combination of ground-engaging tools. In several embodiments, the various ground-engaging tools may be configured to perform a tillage operation or any other suitable ground-engaging operation across the field 16 along which the implement 14 is being towed. It should be understood that, in addition to being towed by the work vehicle 12, the implement 14 may also be a semi-mounted implement connected to the work vehicle 12 via a two-point hitch or the implement 14 may be a fully mounted implement (e.g., mounted the work vehicle's three-point hitch).

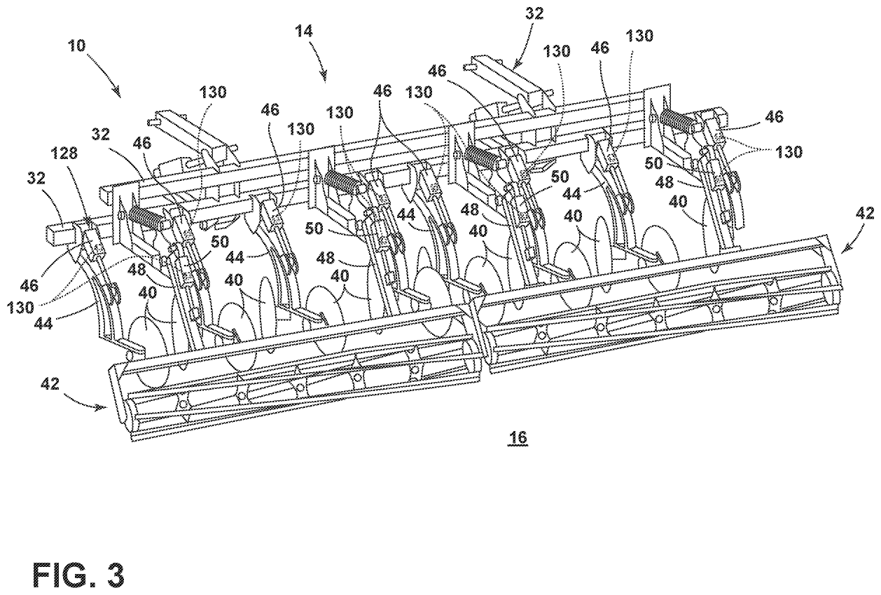

As illustrated in FIG. 3, a leveler support arm 44 may be coupled between the frame assembly 32 and each leveler 40 or a set of levelers 40 to support the levelers 40 relative to the frame assembly 32. In some cases, the levelers 40 may be configured to form a terrain variation in the soil which may be numerically quantified as soil levelness and may be generally characterized by a valley (e.g., a void within a portion of a field 16 below a nominal height of the soil surface having at least a predefined volume), a ridge (e.g., an amount of soil that extends above a nominal height of the soil surface within a portion of a field 16 having at least a predefined volume), or other surface irregularities that extend above or below a nominal height of the soil surface or other reference point or plane by a given height. For example, when the soil is uniform, there are generally no terrain variations across the soil surface, and may be referred to as generally level. However, as terrain variations occur in localized areas, the height of the ridge is generally greater than the nominal height of the soil surface, and/or the depth of the valley generally exceeds the nominal height of the soil surface and may be referred to as non-level. In some instances, the levelers 40 are used to backfill the soil created by various ground-engaging tools. The ridge of soil settles over time due to the soil being loosened. As such, the ridge of soil may be formed to account for the leveling and allow the field 16 to generally level itself due to the settling of the soil.

Additionally, as shown in FIG. 3, in some examples, a leveler actuator 46 (e.g., a hydraulic or pneumatic cylinder) may be respectively coupled to each leveler support arm 44 to allow the downforce or down pressure applied to each leveler 40 to be adjusted. In various instances, different soil types can settle differently (e.g., an amount of settling, a time to settle, etc.). As such, the ridge height and/or valley depth defined by the levelers 40 may be adjusted based at least in part on the soil type. The leveler support arm 44 may also allow the levelers 40 to be raised off the ground, such as when the implement 14 is being operated within its transport mode.

Similarly, one or more basket support arms 48 may be coupled between the frame assembly 32 and an associated basket assembly 42. Additionally, as shown in FIG. 3, in various examples, a basket actuator 50 (e.g., a hydraulic or pneumatic cylinder) may be coupled to each basket support arm 48 to allow the downforce or down pressure applied to each basket assembly 42 to be adjusted. The basket actuators 50 may also allow the basket assemblies 42 to be raised off the ground, such as when the implement 14 is making a headland turn and/or when the implement 14 is being operated within its transport mode.

It will be appreciated that the configuration of the agricultural machine 10 described above and shown in FIGS. 1-3 is provided only to place the present subject matter in an example field of use. Thus, it will be appreciated that the present subject matter may be readily adaptable to any manner of machine configuration, including any suitable work vehicle configuration and/or implement configuration. For example, in an alternative embodiment of the work vehicle 12, a separate frame or chassis may be provided to which the engine, transmission, and drive axle assembly are coupled, a configuration common in smaller tractors. Still other configurations may use an articulated chassis to steer the work vehicle 12 or rely on tires/wheels in lieu of the track assemblies 20, 22. Similarly, as indicated above, the carriage frame assembly 32 of the implement 14 may be configured to support any other suitable combination of type of ground-engaging tools.

Furthermore, in accordance with aspects of the present subject matter, the agricultural machine 10 may include one or more field sensors 52 coupled thereto and/or supported thereon. Each field sensor 52 may, for example, be configured to capture data indicative of one or more conditions of the field 16 along which the machine 10 is being traversed. For example, in several embodiments, the one or more field sensors 52 may be used to collect field data associated with one or more field conditions of the field 16, such as electrical conductivity of the soil, soil moisture level, levelness of the field 16 (e.g., ridges and/or valleys), an amount of crop residue, any amount and/or size of soil clods, and/or any other data indicative of a condition within the field 16. In some cases, the one or more conditions of the field 16 may, in turn, be used to determine a “stickiness” of the soil of the field 16. The stickiness may be a quantitative mechanical characteristic of the adherence properties of the soil to itself. One or more tests may be used to determine whether the soil ranges from non-sticky to plastic, and/or any other level of stickiness therebetween.

In some cases, the detected conditions of the field 16 may be used to determine one or more operating parameters of the implement 14. For example, electrical conductivity data can provide an estimate of clay content in the soil. In general, a higher clay content can lead to a higher likelihood of a ground-engaging tool plugging or experiencing a plugged condition. Additionally or alternatively, the electrical conductivity of the soil may be used to achieve specified soil output characteristics (such as residue sizing, clod sizing, levelness, etc.) from the tillage operation.

In some cases, the one or more field sensors 52 may be provided in operative association with the agricultural machine 10 such that the one or more field sensors 52 has a detection region(s) 54 (FIG. 1) of the field 16 adjacent to the work vehicle 12 and/or the implement 14, such as a detection region(s) 54 of the field 16 disposed in front of, behind, and/or along one or both of the sides of the work vehicle 12 and/or the implement 14. For example, as shown in FIG. 1, in some embodiments, a field sensor 52 may be provided at a forward end portion 56 of the work vehicle 12 to allow the one or more field sensors 52 to capture data of a section of the field 16 disposed in front of the work vehicle 12. Such a forward-located field sensor 52 may allow pre-tillage data of the field 16 to be captured for monitoring or determining conditions of the field 16 (e.g., electrical conductivity of the soil) prior to the performance of a tillage operation. Similarly, as shown in FIG. 1, a second field sensor 52 may be provided at or adjacent to a forward end portion 58 of the implement 14 to allow the one or more field sensors 52 to capture data of a section of the field 16 disposed behind the tractor and forward of the ground-engaging tools. In some cases, one or more field sensors 52 may also be positioned aft of one or more ground-engaging tools, such as aft of one or more ground-engaging tools, which can allow the one or more field sensors 52 to capture post-tillage data of the field 16 to be captured for monitoring or determining conditions of the field 16 (e.g., the electrical conductivity of the soil) after the performance of a tillage operation. Additionally or alternatively, the one or more field sensors 52 may be installed at any other suitable location(s) on the work vehicle 12 and/or the implement 14. In addition, the agricultural machine 10 may only include a single field sensor 52 mounted on either the work vehicle 12 or the implement 14 or may include more than two field sensor 52 mounted on the work vehicle 12 and/or the implement 14. Moreover, it will be appreciated that each field sensor 52 may be configured to be mounted or otherwise supported relative to a portion of the agricultural machine 10 using any suitable mounting/support structure. For instance, each field sensor 52 may be directly or indirectly mounted to a portion of the work vehicle 12 and/or the implement 14.

In various examples, the one or more field sensors 52 may be configured as electrical conductivity sensors configured to measure the electrical conductivity of the soil. The one or more field sensors 52 may be implemented as any practicable contact and/or non-contact sensor. In some instances, the electrical conductivity sensor can include soil-contracting ears 60, 62 disposed to slidingly contact the soil as the implement 14 traverses the field. The ears 60, 62 may be made of an electrically conductive material, such as copper and/or any other practicable material. In addition, the ears 60, 62 may be fixed to and in electrical communication with a sensor hub housed within a sensor body 64.

Additionally or alternatively, the electrical conductivity sensor can measure the electrical conductivity of soil by measuring an electrical potential between the first electrical conductivity sensor, which may be forward of the machine 10, and the second electrical conductivity sensor, which may be aft of the machine 10 (and/or the implement 14).

In other embodiments, the electrical conductivity sensors can be implemented within one or more ground-engaging tools (e.g., discs or shanks) that contact the soil. In such instances, a voltage potential can be detected by each sensor and a potential may be determined. The voltage potential or another electrical conductivity value derived from the voltage potential may be used to determine the electrical conductivity of the soil. It will be appreciated that at least one of the electrical conductivity sensor described herein may be electrically isolated from the other sensor or voltage reference. In some examples, the electrical conductivity sensor is mounted to an implement 14 (e.g., to the planter row unit or tillage tool) by being first mounted to an electrically insulating component (e.g., a component made from an electrically insulating material such as polyethylene, polyvinyl chloride, or a rubber-like polymer) which is in turn mounted to the implement 14.

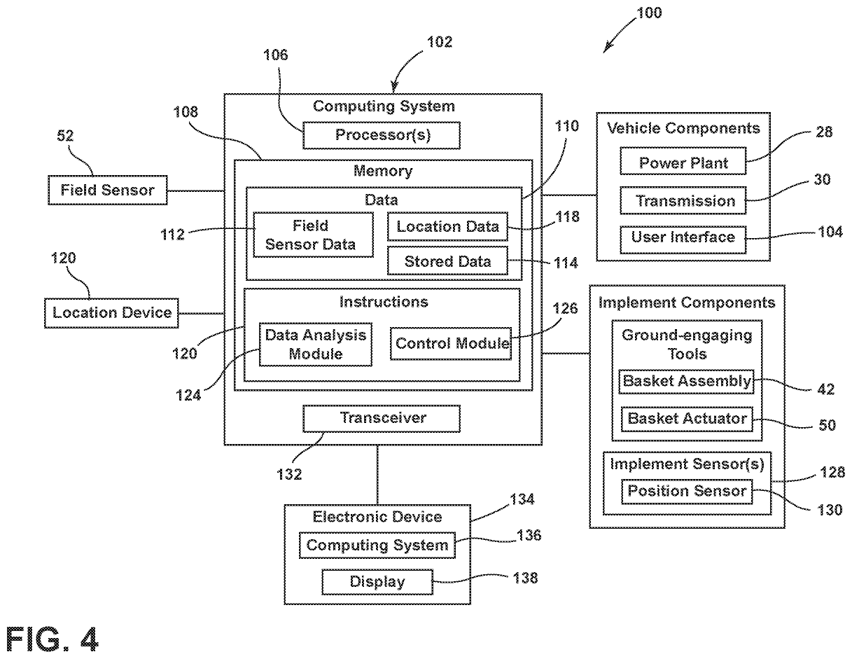

Referring now to FIG. 4, a schematic view of a system 100 for an agricultural machine 10 is illustrated in accordance with aspects of the present subject matter. The system 100 will generally be described herein with reference to the agricultural machine 10 described above with reference to FIGS. 1-3. However, the disclosed system 100 may generally be utilized with agricultural machines having any other suitable machine configuration.

In several embodiments, the disclosed system 100 is configured for detecting electrical conductivity and/or any other field condition to determine the mechanical properties of the soil of the field 16 (FIG. 1). Electrical conductivity measurements can provide an estimate of clay content in the soil. In some cases, the estimated clay content can, in turn, be used to adjust one or more machine settings to reduce a buildup of material, which can lead to a plugged condition. The plugging condition generally occurs more often at higher moisture levels and in higher clay content. In various cases of soil conditions, there is some tradeoff between the selection of machine settings and the probability of plugging. For example, in the case of basket pressure, lower basket pressures result in less plugging but work the soil less and are less likely to match one or more output characteristics, and vice versa. As such, the system 100 provided herein can adjust machine settings based on the tradeoff and reduce the probability of plugging based on measurements of soil properties by deviating from a default position to lower a probability of a plugging condition.

As shown in FIG. 4, the system 100 may include one or more field sensors 52 configured to capture data indicative of various conditions of a detection region(s) 54 of the field 16 disposed adjacent to the work vehicle 12 and or the implement 14. Additionally, the system 100 may include or be associated with one or more components of the agricultural machine 10 described above with reference to FIGS. 1-3, such as one or more components of the work vehicle 12 and/or the implement 14.

The system 100 may further include a computing system 102 communicatively coupled to the one or more field sensors 52. In several embodiments, the computing system 102 may be configured to receive and process the data captured by the one or more field sensors 52. For instance, the computing system 102 may be configured to receive field data indicative of the electrical conductivity of the soil and execute one or more suitable data processing algorithms for determining a determined clay content based on the electrical conductivity. Additionally or alternatively, a field condition may be provided to the computing system 102 through any other manner, such as through a field map and/or through inputted field data. In turn, the computing system 102 may determine a defined position of the one or more ground-engaging tools based in part on the field conditions. In some cases, as the field conditions within the field 16 vary, the position of one or more ground-engaging tools (e.g., the basket assembly 42) may be adjusted.

In various examples, one or more defined output characteristics for the field 16 may be defined, which may be provided by a user interface 104. The one or more defined output characteristics can include a levelness of the field 16, an amount of clods, a size of clods, an amount of residue, etc. In turn, the computing system 102 can be configured to determine a defined basket actuator 50 position based at least partially on the clay content, the soil moisture level, the measured field conditions of the field 16, and/or the defined output characteristic.

In general, the computing system 102 may include any a suitable processor-based device, such as a computing device or any suitable combination of computing devices. Thus, in several embodiments, the computing system 102 may include one or more processors 106 and associated memory 108 configured to perform a variety of computer-implemented functions. As used herein, the term “processor” refers not only to integrated circuits referred to in the art as being included in a computer, but also refers to a controller, a microcontroller, a microcomputer, a programmable logic controller (PLC), an application specific integrated circuit, and other programmable circuits. Additionally, the memory 108 of the computing system 102 may generally comprise memory element(s) including, but not limited to, a computer-readable medium (e.g., random access memory (RAM)), a computer-readable non-volatile medium (e.g., a flash memory), a floppy disk, a compact disc-read only memory (CD-ROM), a magneto-optical disk (MOD), a digital versatile disc (DVD) and/or other suitable memory elements. Such memory 108 may generally be configured to store suitable computer-readable instructions that, when implemented by the processors 106, configure the computing system 102 to perform various computer-implemented functions, such as one or more aspects of the data processing algorithm(s) and/or related method(s) described below. In addition, the computing system 102 may also include various other suitable components, such as a communications circuit or module, one or more input/output channels, a data/control bus, and/or the like.

It will be appreciated that, in several embodiments, the computing system 102 may correspond to an existing controller of the agricultural machine 10, or the computing system 102 may correspond to one or more separate processing devices. For instance, in some embodiments, the computing system 102 may form all or part of a separate plug-in module or computing device(s) that is installed relative to the work vehicle 12 or implement 14 to allow for the disclosed system 100 and method to be implemented without requiring additional software to be uploaded onto existing control devices of the work vehicle 12 or implement 14.

In several embodiments, the memory 108 of the computing system 102 may include one or more databases 110 for storing information received and/or generated by the computing system 102. For instance, as shown in FIG. 4, the memory 108 may include a field sensor database 112 storing data associated with the field data captured by the one or more field sensors 52, including the captured data and/or data deriving from the captured data (e.g., disparity maps, depth images generated based on the captured data by the one or more field sensors 52, etc.). As provided herein, the field data captured by the one or more field sensors 52 can relate to one or more field conditions, such as the electrical conductivity of the soil.

Additionally, the memory 108 may include a stored data database 114 storing data acquired from various sources. For instance, as indicated above, the stored data can include a field map that is generated through any method, such as with a previous agricultural operation, user-entered information, from the one or more field sensors 52, and/or other systems. In various cases, the stored data can relate to one or more field conditions.

Additionally or alternatively, as shown in FIG. 4, the memory 108 may also include a location database 118, which may be configured to store location data generated by a location device 120 that is stored in association with the field data for later use in geo-locating the field data relative to the field 16. In some embodiments, the location device 120 may be configured as a satellite navigation positioning device (e.g. a GPS, a Galileo positioning system, a Global Navigation satellite system (GLONASS), a BeiDou Satellite Navigation and Positioning system, a dead reckoning device, and/or the like) to determine the location of the machine 10.

Moreover, as shown in FIG. 4, in several embodiments, the memory 108 may also include instructions 122 that may be executed by the processor 106 to implement a data analysis module 124. In general, the data analysis module 124 may be configured to process/analyze the captured data received from the one or more field sensors 52, the stored data, and/or the location data. In several embodiments, the data analysis module 124 may be configured to execute one or more data processing algorithms to determine a determined clay content of the soil, a soil moisture level content, and/or a position of the one or more basket assemblies 42. In turn, the computing system 102 may determine a defined position of the one or more basket assemblies 42 based in part on the determined clay content and/or the soil moisture level.

Referring still to FIG. 4, in some embodiments, the instructions 122 stored within the memory 108 of the computing system 102 may also be executed by the processor 106 to implement a control module 126. In general, the control module 126 may be configured to electronically control the operation of one or more components of the agricultural machine 10. For instance, in several embodiments, the control module 126 may be configured to control the operation of the agricultural machine 10. Such control may include controlling the operation of one or more components of the work vehicle 12, such as the power plant 28 and/or the transmission 30 of the vehicle 12 to automatically adjust the ground speed of the agricultural machine 10. In addition (or as an alternative thereto), the control module 126 may be configured to electronically control the operation of one or more components of the implement 14. For instance, the control module 126 may be configured to adjust the operating parameters (e.g., penetration depth, downforce/pressure, etc.) associated with one or more of the ground-engaging tools of the implement 14 (e.g., the disc blades 36, shanks 38, levelers 40 (e.g., leveling blades), and/or basket assemblies 42) to proactively or reactively adjust the operation of the implement 14 in view of the field conditions and/or defined output characteristics.

In instances in which one or more operating parameters are adjusted, the actuation of one or more implement components may be based on data from one or more implement sensors 128. For example, the one or more implement sensor 128 can include a position sensor 130 operably coupled with the machine 10 may detect the change in position. In some examples, the position sensor 130 may be configured as an inertial measurement unit (IMU) that measures a specific force, angular rate, and/or an orientation of the implement 14 using a combination of accelerometers, gyroscopes, magnetometers, and/or any other practicable device. The accelerometer may correspond to one or more multi-axis accelerometers (e.g., one or more two-axis or three-axis accelerometers) such that the accelerometer may be configured to monitor the movement of the implement 14 in multiple directions, such as by sensing the implement acceleration along three different axes. It will be appreciated, however, that the accelerometer may generally correspond to any suitable type of accelerometer without departing from the teachings provided herein.

In some instances, the computing system 102 may determine a defined position of the basket assemblies 42 based on the clay content and an actual position of the basket assemblies 42 based on data from the position sensor 130. When there is a variation between the defined position and the actual position, the control module 126 can generate instructions 122 for the basket actuator 50 to activate and move the basket assembly 42 so that the actual position and the defined position are generally common with one another and/or within a defined range of one another.

In several embodiments, the computing system 102 may also include a transceiver 132 to allow for the computing system 102 to communicate various components. For instance, one or more communicative links or interfaces (e.g., one or more data buses) may be provided between the transceiver 132 and the user interface 104, an electronic device 134, and/or any other device.

The user interface 104 may be housed within the cab 26 of the work vehicle 12 or at any other suitable location. The user interface 104 may be configured to provide feedback to the operator of the agricultural machine 10. Thus, the user interface 104 may include one or more feedback devices, such as display screens, speakers, warning lights, and/or the like, which are configured to communicate such feedback. In addition, some embodiments of the user interface 104 may include one or more input devices, such as touchscreens, keypads, touchpads, knobs, buttons, sliders, switches, mice, microphones, and/or the like, which are configured to receive user inputs from the operator.

The electronic device 134 may include a variety of computing systems 136 including a processor and memory and/or a display 138 for displaying information to a user. For instance, the electronic device 134 may display one or more user interfaces and may be capable of receiving remote user input. In addition, the electronic device 134 may provide feedback information, such as visual, audible, and tactile alerts, and/or allow the operator to alter or adjust one or more components of the agricultural machine 10 through the usage of the remote electronic device 134. For example, the electronic device 134 may be a cell phone, mobile communication device, key fob, wearable device (e.g., fitness band, watch, glasses, jewelry, wallet), apparel (e.g., a tee shirt, gloves, shoes, or other accessories), personal digital assistant, headphones and/or other devices that include capabilities for wireless communications and/or any wired communications protocols.

It will be appreciated that, although the various control functions and/or actions will generally be described herein as being executed by the computing system 102, one or more of such control functions/actions (or portions thereof) may be executed by a separate computing system or may be distributed across two or more computing systems (including, for example, the computing system 102 and a separate computing system). For instance, in some embodiments, the computing system 102 may be configured to acquire data from the one or more field sensors 52 for subsequent processing and/or analysis by a separate computing system (e.g., a computing system associated with a remote server). In other embodiments, the computing system 102 may be configured to execute the data analysis module 124 to determine and/or monitor one or more surface conditions within the field 16, while a separate computing system (e.g., a vehicle computing system 102 associated with the agricultural machine 10) may be configured to execute the control module 126 to control the operation of the agricultural machine 10 based on data and/or instructions 122 transmitted from the computing system 102 that are associated with the monitored surface condition(s).

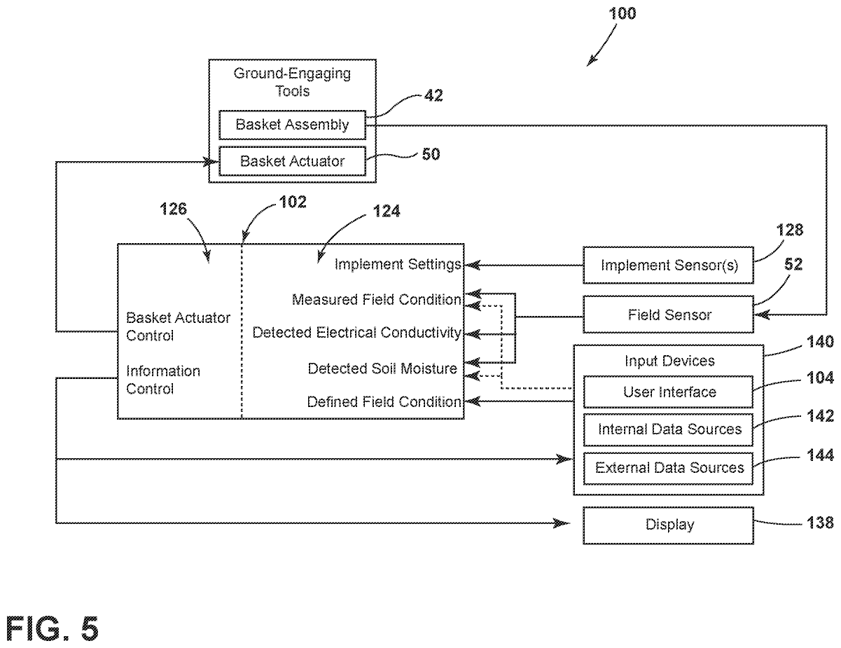

Referring to FIG. 5, various components of the system 100 are illustrated in accordance with various aspects of the present disclosure. As shown, the data analysis module 124 may receive data from various components of the system 100, such as via the one or more field sensors 52, the implement sensor 128, and/or one or more input devices 140, and, in turn, the control module 126 can alter or manipulate various components of the implement 14, such as the basket actuators 50. As provided herein, the data analysis module 124 can receive various inputs and calculate a defined position for each basket actuator 50 based at least in part on a determined clay content and/or a current position of each basket assembly 42.

As illustrated, the data analysis module 124 may receive various implement settings from one or more implement sensor 128 configured to detect one or more implement settings associated with the implement 14. In addition, the data analysis module 124 can receive a measured field condition from one or more field sensors 52, such as data indicative of an electrical conductivity of the soil within the field 16 and/or a soil moisture level from the one or more field sensors 52. Additionally or alternatively, the field data can be inputted through one or more input devices 140. In various cases, the one or more input devices 140 can include one or more user interfaces 104 for allowing operator inputs to be provided to the computing system 102 (e.g., buttons, knobs, dials, levers, joysticks, touch screens, and/or the like), one or more other internal data sources 142 associated with the agricultural machine 10 (e.g., other devices, stored data, databases, etc.), one or more external data sources 144 (e.g., a remote computing device or server), and/or any other suitable input devices 140. Further, the data analysis module 124 may receive a defined output characteristic from the input devices 140. In some cases, the defined output characteristic can be a numerical value that defines a desired output characteristic from the tillage operation.

The data analysis module 124 can receive the data indicative of electrical conductivity and, in turn, determine the clay content of the soil. Additionally or alternatively, the data analysis module 124 can receive data indicative of a soil moisture level. Based on the clay content and/or the detected soil moisture level, the data analysis module 124 may determine a probability of a plugged condition with the basket assembly 42 in various positions relative to the field 16 (FIG. 1) and/or the frame assembly 32. For example, the data analysis module 124 can determine a probability of a plugging condition based on the soil moisture level of the soil within the field 16 and the defined basket actuator position being at a default pressure, which may be defined as a defined pressure to accomplish the defined output characteristics. In some cases, the probability range may take precedence in determining basket assembly position over the default pressure. For instance, if a user desires to reduce the potential of a plugged condition, the data analysis module 124 can receive the field data and, in turn, define a first position for the basket assemblies 42 that is less likely to lead to a plugged condition. Alternatively, if a user desires to match a defined output characteristic rather than reduce the chances of the potential of a plugged condition, the data analysis module 124 can receive the field data and, in turn, define a second position for the basket assemblies 42 that may better match the defined output characteristic but may also increase the potential of a plugged condition.

Additionally, the data analysis module 124 can receive the field data and compare the defined output characteristic to the measured field condition based on field data. If a variation exists between the defined output characteristic to the measured field condition, the data analysis module 124 can generate an amount of movement of the one or more basket assemblies 42 through the actuation of the respective basket actuators 50. In response, the control module 126 may generate instructions 122 to alter a position of the basket assembly 42 through actuation of the basket actuator 50 when a detected basket assembly position varies from the defined basket position. Additionally or alternatively, the control module 126 may generate display instructions 122 for one or more displays 138, which may be incorporated within the user interface 104 and/or be remote from the user interface 104. For instance, the display 138 may illustrate information related to at least one of the estimated clay content, the measured field condition of the field 16, the defined output characteristic of the field 16, and/or the probability of a plugged condition with the basket assembly 42 in various positions relative to the frame based at least in part on the estimated clay content and/or soil moisture level. In some cases, the input devices may determine a probability range of operation for the basket assemblies 42 and/or any other component of the implement 14.

During operation, data may be sequentially collected by the one or more field sensors 52 and/or the implement sensor 128, which may be provided as subsequent inputs to the data analysis module 124 so that additional alterations to one or more basket actuators 50 may be made, if needed. In addition, the data analysis module 124 may alter one or more subsequent outputs based on a result of a previous instruction. As such, the data analysis module 124 may learn from the results of previous instructions to alter subsequent instructions.

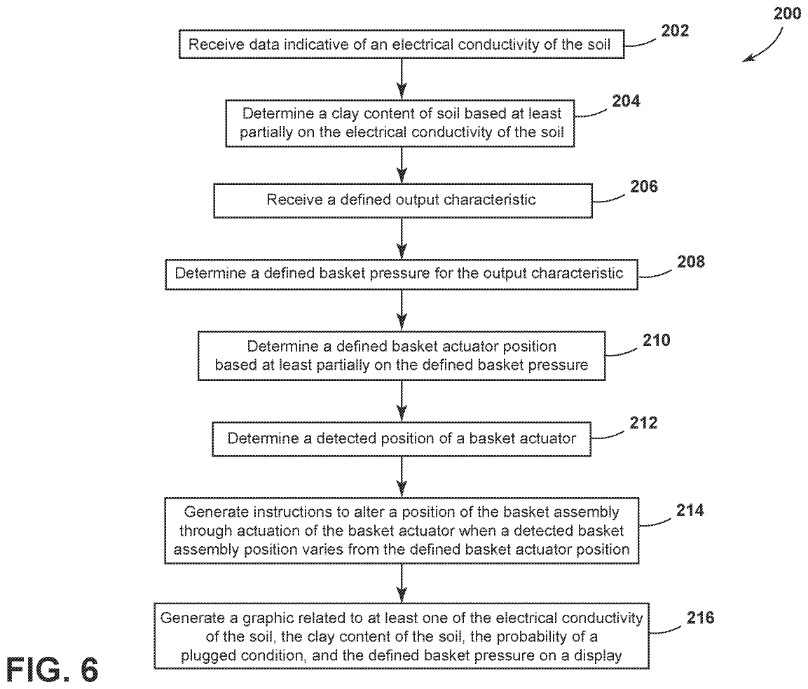

Referring now to FIG. 6, a flow diagram of a method 200 for method for operating an agricultural system is illustrated in accordance with aspects of the present subject matter. In general, the method 200 will be described herein with reference to the agricultural machine 10 shown in FIGS. 1-3 and the various system components shown in FIGS. 4 and 5. However, it will be appreciated that the disclosed method 200 may be implemented with agricultural machines having any other suitable machine configurations and/or within systems having any other suitable system configuration. In addition, although FIG. 6 depicts steps performed in a particular order for purposes of illustration and discussion, the methods discussed herein are not limited to any particular order or arrangement. One skilled in the art, using the disclosures provided herein, will appreciate that various steps of the methods disclosed herein can be omitted, rearranged, combined, and/or adapted in various ways without deviating from the scope of the present disclosure.

As illustrated, at (202), the method 200 can include receiving data indicative of an electrical conductivity of the soil from one or more field sensors. As provided herein, the one or more field sensors may be provided at a forward end portion of the work vehicle to allow the one or more field sensors to capture data of a section of the field disposed in front of the work vehicle. Such a forward-located field sensor may allow pre-tillage data of the field to be captured for monitoring or determining conditions of the field (e.g., the electrical conductivity of the soil) prior to the performance of a tillage operation. Additionally or alternatively, one or more field sensors may be provided at or adjacent to a forward end portion of the implement to allow the one or more field sensors to capture data of a section of the field disposed behind the tractor and forward of the ground-engaging tools. In some cases, the one or more field sensors may also be positioned aft of one or more ground-engaging tools, such as aft of one or more ground-engaging tools, which can allow the one or more field sensors to capture post-tillage data of the field to be captured for monitoring or determining conditions of the field (e.g., electrical conductivity of the soil) after the performance of a tillage operation.

At (204), the method 200 can include determining a determined clay content of soil based at least partially on the electrical conductivity of the soil with a computing system. In general, a higher clay content can lead to a high likelihood of a ground-engaging tool plugging or experiencing a plugged condition. Additionally or alternatively, the electrical conductivity of the soil may be used to achieve specified soil output characteristics (such as residue sizing, clod sizing, levelness, etc.) from the tillage operation.

At (206), the method 200 can include receiving a defined output characteristic with the computing system. At (208), method 200 can include determining a defined basket pressure for the defined output characteristic with the computing system. In turn, at (210), the method 200 can include determining a defined basket actuator position based at least partially on the defined basket pressure with the computing system for the defined output characteristic.

At (212), the method 200 can include determining a detected position of a basket actuator with a position sensor. At (214), the method 200 can include generating instructions to alter a position of the basket assembly through actuation of the basket actuator when a detected basket assembly position varies from the defined basket actuator position with the computing system.

At (216), the method 200 can include generating a graphic related to at least one of the electrical conductivity of the soil, the clay content of the soil, the probability of a plugged condition, and the defined basket pressure on a display with the computing system.

In various examples, the method 200 may implement machine learning methods and algorithms that utilize one or several machine learning techniques including, for example, decision tree learning, including, for example, random forest or conditional inference trees methods, neural networks, support vector vehicles, clustering, and Bayesian networks. These algorithms can include computer-executable code that can be retrieved by the computing system and/or through a network/cloud and may be used to evaluate and update the boom deflection model. In some instances, the machine learning engine may allow for changes to the boom deflection model to be performed without human intervention.

It is to be understood that the steps of any method disclosed herein may be performed by a computing system upon loading and executing software code or instructions that are tangibly stored on a tangible computer-readable medium, such as on a magnetic medium, e.g., a computer hard drive, an optical medium, e.g., an optical disc, solid-state memory, e.g., flash memory, or other storage media known in the art. Thus, any of the functionality performed by the computing system described herein, such as any of the disclosed methods, may be implemented in software code or instructions that are tangibly stored on a tangible computer-readable medium. The computing system loads the software code or instructions via a direct interface with the computer-readable medium or via a wired and/or wireless network. Upon loading and executing such software code or instructions by the controller, the computing system may perform any of the functionality of the computing system described herein, including any steps of the disclosed methods.

The term “software code” or “code” used herein refers to any instructions or set of instructions that influence the operation of a computer or controller. They may exist in a computer-executable form, such as vehicle code, which is the set of instructions and data directly executed by a computer's central processing unit or by a controller, a human-understandable form, such as source code, which may be compiled in order to be executed by a computer's central processing unit or by a controller, or an intermediate form, such as object code, which is produced by a compiler. As used herein, the term “software code” or “code” also includes any human-understandable computer instructions or set of instructions, e.g., a script, that may be executed on the fly with the aid of an interpreter executed by a computer's central processing unit or by a controller.

This written description uses examples to disclose the technology, including the best mode, and also to enable any person skilled in the art to practice the technology, including making and using any devices or systems and performing any incorporated methods. The patentable scope of the technology is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

What is claimed is:

1. An agricultural system comprising:
an implement including a frame assembly;
a basket assembly operably coupled with the frame assembly;
a basket actuator operably coupled with the basket assembly and the frame assembly, the basket actuator configured to alter a position of the basket assembly relative to the frame assembly; and
a computing system communicatively coupled to the basket actuator, the computing system including a processor and associated memory, the memory storing instructions that, when implemented by the processor, configure the computing system to:
receive a defined output characteristic;
receive data indicative of a determined clay content of soil within a field; and
determine a defined basket actuator position based at least partially on the clay content of the soil within the field and the defined output characteristic.

2. The agricultural system of claim 1, wherein the data indicative of a determined clay content of soil within the field includes electrical conductivity data.

3. The agricultural system of claim 1, further comprising:
one or more field sensors configured to capture data indicative of the clay content of the soil.

4. The agricultural system of claim 3, wherein the one or more field sensors are positioned forward of the basket assembly.

5. The agricultural system of claim 1, wherein the computing system is further configured to:
determine a probability of a plugging condition based on the clay content of the soil within the field and the defined basket actuator position being at a default pressure.

6. The agricultural system of claim 1, wherein the computing system is further configured to:
receive an input related to a defined probability range,
wherein the defined basket actuator position is based at least partially on a probability range of a plugged condition as determined by the clay content of the soil within the field and the defined output characteristic.

7. The agricultural system of claim 1, further comprising:
a user interface, wherein the clay content of the soil is provided to the computing system through the user interface.

8. The agricultural system of claim 1, wherein the computing system is further configured to:
receive data indicative of a soil moisture level from one or more field sensors.

9. The agricultural system of claim 8, wherein the computing system is further configured to:
determine a probability of a plugging condition based on the soil moisture level of the soil within the field and the defined basket actuator position being at a default pressure.

10. The agricultural system of claim 1, further comprising:
a location device, wherein the clay content of the soil is based at least partially on a position of the implement within a field, as determined by the location device, and a correlated field map.

11. The agricultural system of claim 1, further comprising:
a position sensor operably coupled with the basket actuator, the position sensor configured to capture data indicative of a detected position of the basket assembly relative to the frame assembly.

12. The agricultural system of claim 11, wherein the computing system is further configured to:
generate instructions to alter a position of the basket assembly through actuation of the basket actuator when a detected basket assembly position varies from the defined basket actuator position.

13. A method for operating an agricultural system, the method comprising:
receiving, from one or more field sensors, data indicative of an electrical conductivity of soil; and
determining, with a computing system, a determined clay content of soil based at least partially on the electrical conductivity of the soil.

14. The method of claim 13, further comprising:
receiving, with the computing system, a defined output characteristic; and
determining, with the computing system, a defined basket pressure for the defined output characteristic.

15. The method of claim 14, further comprising:
determining, with the computing system, a defined basket actuator position based at least partially on the defined basket pressure.

16. The method of claim 15, further comprising:
determining, with a position sensor, a detected position of a basket actuator.

17. The method of claim 16, further comprising:
generating, with the computing system, instructions to alter a position of a basket assembly through actuation of the basket actuator when a detected basket assembly position varies from the defined basket actuator position.

18. An agricultural system comprising:
an implement including a frame assembly;
a basket assembly operably coupled with the frame assembly;
a basket actuator operably coupled with the basket assembly and the frame assembly, the basket actuator configured to alter a position of the basket assembly relative to the frame assembly;
one or more field sensors; and
a computing system communicatively coupled to the basket actuator, the computing system including a processor and associated memory, the memory storing instructions that, when implemented by the processor, configure the computing system to:
receive data indicative of an electrical conductivity of soil;
determine a determined clay content of soil within the field based on the electrical conductivity of the soil; and
determine a defined basket actuator position based at least partially on the clay content of the soil within the field.

19. The agricultural system of claim 18, further comprising:
a display operably coupled with the computing system, the computing system configured to illustrate information related to at least one of an estimated clay content, a measured field condition, a defined output characteristic, and a probability of a plugged condition with the basket assembly in various positions relative to the frame.

20. The system of claim 18, wherein the defined basket actuator position is further based at least in part on a soil moisture level of the soil within the field.
